(19) United States
(12) Patent Application Publication
(10) Pub. No.: US 2007/0240614 A1
(43) Pub. Date: Oct. 18, 2007

(54) Film forming coating composition

(76) Inventor: Thomas J. Lynch, Roswell, GA (US)

Correspondence Address: Carlos Nieves, Esq.;J.M. Huber Corporation, 333 Thornall Street, Edison, NJ, 08837-2220, US

(21) Appl. No.: 10/881,359

(22) Filed: Jun. 30, 2004

(51) Int. Cl. C08L 43/04

(52) U.S. Cl. 106/287.14; 106/287.1

(57) ABSTRACT

A coating composition useful for forming a film is provided, comprising, in admixture, a resin and finely divided clay that has been surface treated with a silicon-hydride containing polysiloxane.

### BACKGROUND OF THE INVENTION

Protective surface coatings are used in a wide variety of applications to provide a thin film barrier between the surface of a body needing protection and its immediate surrounding environment. Protective coatings of this sort have been used, for instance, on marine, aircraft, and industrial structures and parts. These protective coatings often are formulated to include a curable organic medium, pigments, and inorganic filler particles dispersed within the medium.

It is well known that the proper selection of the pigments, as differentiated from the fillers, has a profound influence on protective and other functional properties of protective coatings. The pigments provide many of the essential properties of the coating such as color, corrosion protection, durability and special rheological properties that address the practical aspects of coating application such as ease of application and firm build. Many conventional fillers used in coatings are commodities having lower cost than the base resin of the coating. For this reason, fillers are often used to reduce the cost of the coating.

The traditional coating requirements of increased performance, reduced cost, as well as compliance with regulations drive much of new coatings formulation, and are largely responsible for the elimination of the older thermoplastics (lacquers) and the increase in higher solids thermosets and water borne technologies, as well as more revolutionary advances.

In particular, regulation compliance is driving one of the most important coating formulations changes, which is the elimination of corrosion resistant inhibitive coating systems based on lead and hexavalent chromium because of toxicity considerations. Any coating additive that attenuates the need for toxic corrosion inhibitors is highly desired.

Coatings that have been more recently introduced have serious drawbacks. For example, the toxicologically and environmentally safer corrosion inhibitors are either not as effective or as universally applicable as the traditional corrosion inhibitors, such as lead and the hexavalent chromium salts. This has resulted in a swing away from coating systems based on inhibitive pigments toward coatings that incorporate sacrificial pigments such as zinc. This second approach also has limitations. Zinc-rich technologies require good contact between the steel of the substrate and the zinc and this limits these systems to new steel or old steel that has been blasted clean. Old steel that is covered with lead and chromium based coatings must first be blasted clean which undesirably puts lead and chromium debris into the environment. Attempts to contain the debris and its removal and disposal as hazardous material is excessively costly and severely impedes any impetus towards such surface preparation and the use of such zinc-rich coatings on steel covered with lead or chromium based coatings.

A third technique to combat corrosion is the barrier technique. Barrier coatings protect metallic substrates by interposing an oxygen and ionic barrier between the substrate and the environment and ensures that any water that does penetrate the film is filtered of all ionic material so that the electrical resistance of any underfilm electrolyte is too high to allow the establishment of a corrosion current.

Barrier coatings have traditionally been formulated with flat platy pigments (aluminum and stainless steel flake, mica, micaceous iron oxide, talc, glass flake, etc.). The flat, platy pigment shape is believed to enhance the barrier properties of the coating. Unfortunately, many of these pigments have two important defects. First, they are often reactive and sensitive to various chemical species. For example, aluminum is sensitive to acids and alkalis, while glass flake may be affected by alkalis. Secondly, they have high oil absorption values because of their high surface area and therefore make high viscosity coatings that cannot be applied without large solvent additions (high VOC).

Therefore, a need still exists for enhanced corrosion performance with respect to resin-based thin film forming protective coatings while also providing acceptably low VOC contents and reduced health and environmental risks.

### BRIEF SUMMARY OF THE INVENTION

The present invention includes a coating composition useful for forming a film, comprising, in admixture, a resin and finely divided clay that has been surface treated with a silicon-hydride containing polysiloxane.

The present invention includes a method of providing a coating film on a solid substrate surface comprising: applying a coating composition on the substrate surface in film form, wherein the coating composition comprises a resin system, and a dispersion in the resin system, wherein the dispersion comprises a pigment including clay particles surface treated with a silicon-hydride containing polysiloxane, and drying or permitting drying of the film to form a dried film from the applied coating composition, which film is attached to the solid substrate surface.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 shows photographs of epoxy-cycloaliphatic amine coatings on steel panels after being exposed to 720 hours of 5% salt spray. The coating of FIG. 1A contains a clay blend that was not surface modified while the coating in FIG. 1B contains a clay blend surface modified with a silicon-hydride containing polysiloxane, polymethylhydrogensiloxane (PHS). The same panels with the coatings removed are shown in FIG. 2 in order to expose the extent of corrosion under the coatings.

FIG. 3 shows photographs of the epoxy-polyamide coated steel panels which were exposed to 5% salt spray for 744 hours with bottom half of the coating removed to show the extent of corrosion under the coatings. Thus photograph A shown in FIG. 3 is of the coating containing a blended clay that was not surface modified, and photograph B is of the coating containing blended clay surface modified with polymethylhydrogensiloxane.

### DETAILED DESCRIPTION OF THE INVENTION

All parts, percentages and ratios used herein are expressed by weight unless otherwise specified. All documents cited herein are incorporated by reference.

The present invention is directed toward a film forming coating composition containing a resin and a surface treated clay particulate product that provides improved barrier, wet adhesive, blister resistant, anti-corrosion protection in polymeric coating applications, and in a more environmentally friendly manner by minimizing the need for toxic pigments in the coating compositions.

In one aspect, the film forming coating composition forms films endowed with unexpectedly high resistance to blistering as compared to similar coating compositions except containing clay that has not been surface treated or alternatively has been surface treated with surface reagents other than silicon-hydride polysiloxane.

For purposes herein, the term “silicon-hydride polysiloxane” generally relates to a polysiloxane oligomer or polymer that contains a silicon-hydride bond. In one embodiment, the clay is used in a finely divided form, such as particles having a median particle size of about 0.1 to about 10 microns. In one embodiment, the silicon-hydride polysiloxane is added onto the surface of the clay in an amount of about 0.1% to about 2% by weight, and particularly about 0.25% to about 1.5% by weight, based on dry weight of the clay before the addition. In one embodiment, the clay particles are pretreated with a silicon-hydride polysiloxane compound before their introduction into a coating composition. In another embodiment, the silicon-hydride polysiloxane can be deposited on the clay via a liquid medium into which both have been dispersed.

In one embodiment, the resin component of the coating compositions is a curable resin that is susceptible to being crosslinked to form a thermoset resin in a thin film form of the coating composition. The curable resin can be, for example, an epoxy resin, an isocyanate based urethane or urea resin, an alkyd resin, a thermosetting acrylic(copolymer) resin, a polyester resin, a phenolic resin, a thermosetting polyvinyl resin, a blocked isocyanate resin, and so forth, and mixtures of these. The term “curable” means a monomer, oligomer, or polymer that forms a higher molecular weight polymeric chain and/or network when crosslinked. In one embodiment, the curable resin is a crosslinkable resin forming a thermoset. “Crosslinking” means the setting up of chemical links between molecular chains of a resin to form a three-dimensional network polymer system. Crosslinking generally toughens and stiffens the coatings. A “thermoset” is a resin, when cured by application of heat, chemical or other crosslinking inducing or promoting means, changes into a substantially infusible and insoluble material. Thermosetting resins may soften but will not dissolve in any solvents, unlike thermoplastic resins. The coating composition can include curing agents or initiators or accelerators as applicable or needed.

The coating film prepared from a coating composition of embodiments of this invention that includes a curable resin hardens as the resin or binder cures, and thus becomes more durable, among other attributes. In another embodiment, the resin included in the coating composition is a thermoplastic resin. The thermoplastic resins possess long, mostly unbranched backbones held close together to each other by secondary valency bonds. The thermoplastic resins can be, for example, polyacrylics, polyvinyl resins, and so forth.

In yet another embodiment, the resin included in the coating composition provides a coalescing system, which is a water-based coating in which the film forms when water evaporates from an emulsion or latex system. As evaporation occurs, adjacent latex particles come into contact with each other and fuse to form a solid film. In this aspect, the emulsion or latex can contain precured solids comprising thermoset or thermoplastic particles.

The coatings can be air-dried or baked coatings. For purposes herein, a “coating” is a liquid or mastic composition that is converted to a solid protective, decorative, or functional adherent film after application as a thin layer.

In one embodiment, the coating compositions can be in the form of a dispersion coating, emulsion, or latex. The compositions of the present invention form durable continuous dried thin films that generally can have an average film thickness, upon drying, of about 1×10⁻³ to about 25×10⁻³ inch, more particularly about 2×10⁻³ to about 15×10⁻³ inch. In one preferred embodiment, the coating composition resin system comprises a curable resin side and a curing agent side. The pigment is dispersed in either the curable resin side or the curing agent side or both. In a particular embodiment, the coating composition is a two part epoxy resin coating system comprised by a curable epoxy resin in one part and an amine hardening agent included in a second part, which upon admixture induces curing and hardening of the epoxy resin. The surface treated clay, and any other pigments, can be included in either or both parts. The epoxy or other curable resin included binds the additive particles together to form a film. For purposes herein, a “film” can be comprised of one or more layers of coating covering an object or surface.

In addition to its anti-corrosion effects, the surface-treated clay also can be used as a filler in the coating compositions. Therefore, the surface treated clay can be multifunctional as used in the coating compositions. Other mineral based pigments and fillers optionally can be included with it in the coating composition. Colored organic and inorganic pigments may also be used to color the product. The coating compositions also optionally can contain commonly used chemical additives for protective coating compositions such as corrosion, oxidation, drying, and/or skinning retardants, stabilizers, ultraviolet absorbers, thixatropes, and flow control additives.

The coating composition is preferably used as a surface-coating material. The film forming coating compositions of this invention are ready-to-use formulations that can be applied and distributed over a portion of a surface or substrate to be coated by any convenient method and means. The coating compositions of the present invention can be readily formulated in flowable liquid form. They can be used, for example, as anticorrosive primers, chemical resistance coatings, sealers, top coats, varnishes, and tank linings. These coatings can be applied to a surface by spraying, brushing, dipping, or rolling, or any other suitable technique. Applications of the coating compositions include metal corrosion protection (e.g., marine, pipelines, tanks, and the like), waterproofing (e.g., fabrics, concrete), mechanical protection (e.g., optical surfaces, indoor flooring), and electrical insulation (e.g., wires). In one preferred aspect, the coating compositions are useful as protective coatings, such as surface coatings and linings, such as applied to surfaces of solid metallic substrates. The metallic substrates can be, for example, iron, steel, copper, zinc or aluminum, and their alloys.

The present invention also encompasses methods of application of the coating compositions described herein, which will subsequently be described in greater detail.

Surface Treated Clay

In one embodiment, the clay particles are pretreated with a silicon-hydride polysiloxane compound before their introduction into a coating composition. The method includes mixing a silicon-hydride polysiloxane, in neat or in aqueous emulsion or solution form, with a quantity of clay particles, and then optionally drying the resultant mixture. In this manner, the silicon-hydride polysiloxane is deposited on and chemically condenses on the exterior surface of the clay particles. The silicon-hydride polysiloxane compound binds to the surface of the clay particles through hydrolysis and condensation.

The treatment level of the silicon-hydride polysiloxane compound on the clay component of the coating composition generally can range from about 0.1% to about 2.0% by weight, and particularly is from about 0.25% to about 1.5% by weight, based on dry weight of the clay before the addition.

The surface reagents used to surface treat the clay component of the coating compositions can be polysiloxane compounds having silicon-hydride moieties.

An illustrative example of the chemical structure of a class of silicon-hydride polysiloxanes useful in preparing the surface treated clay products of this invention is set forth immediately below as Structure 1:
Structure 1: 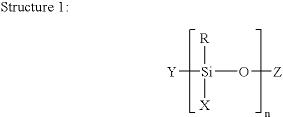
wherein n is an integer greater than 1; X is H at least once per molecule or R′; R or R′=an organic substituent comprising 1 to 20 carbon atoms; and Y and Z=silicon-containing terminating end groups.

The coating composition generally includes pigment in an amount of about 1 to about 65% by volume, particularly about 5 to about 55% by volume of the coating without solvents. This pigment volume is generally reported as “pigment volume concentration (PVC). The surface treated clay, in turn, comprises about 1 to about 100% by volume of the pigment, particularly about 10 to about 70% of the total volume of the pigment. Based on the dry weight of the coating composition, the clay particles comprise about 1 to about 90%, particularly about 20 to about 55%, of the dry weight of the coating composition.

In one embodiment, the clay used as the substrate for the polysiloxane compound containing the silicon-hydride moiety is used in a finely divided form, such as in fine particle form. In one aspect, the clay particles have a median particle size of about 0.1 to about 10 microns and is kaolinite clay.

Naturally occurring clays are frequently used as extender pigments in coatings and composites due to their chemical inertness, high brightness, low abrasiveness, and reinforcement properties.

In a preferred embodiment, a dry water-washed clay is subsequently surface treated with a polysiloxane having a silicon-hydride moiety prior to introduction to a coating composition in a manner more fully described below.

Table 1 sets forth some mineral properties of a typical water-washed kaolinite clay that can be used as a starting material for the practice of this invention. Table 2 sets forth some physical properties of two different, dry clay products available from J.M. Huber Corporation, which can be used in practicing this invention.

TABLE 1

| Kaolin Clay Properties | |
|---|---|
| Morphology | Platy |
| Refractive Index | 1.56-1.62 |
| Specific Gravity | 2.58-2.62 |
| Mohs Hardness | 1.5-2.0 |
| Solubility (g/100 ml) | Negligible |
| Dielectric Constant | 1.3-2.6 |
| Bulking Value (gal/lb) | 0.046 |

TABLE 2

| | Polygloss ® 90 | Huber ®35 |
|---|---|---|
| General Specifications | | |
| Moisture %, 105° C.(max) | 1.0 | 0.5 |
| Screen residue, 325 mesh | 0.01 | 0.025 |
| (max), % | | |
| pH (100 g/250 ml H₂O) | 6-8 | 6.7 |
| Dry brightness, % reflectance | 90-92 | 84 |
| Hegman Grind | 6.5+ | 4.0+ |
| Typical Physical Properties | | |
| Form | Fine Powder | Fine Powder |
| Avg. Stokes equiv. particle | 0.2 | 2.5 |
| diameter, microns | | |
| Median particle size, LLS, | 0.90 | 7.7 |
| microns | | |
| Surface area, BET (m²/g) | 22 | 9.5 |
| Oil absorption (g/100 g) | 46 | 27 |
| Bulk density, loose (lb/ft³) | 13 | 28 |
| Bulk density, tapped (lb/ft³) | 21 | 31 |

The physical and chemical data reported herein were determined as follows. Specific gravities were determined by helium gas displacement using a Quantachrome 1000 automated pycnometer unit. The moisture content on the clay in wt. % was determined by drying test samples in a forced air oven at 105° C. for approximately 2 hours in accordance with the TAPPI Method T671 cm-85 procedure. Screen residue values for an untreated clay were measured by pouring a well-mixed slurry of the clay through a 325 mesh screen, rinsing, drying and weighing the residue, following the ASTM D-185 procedure. Clay pH values were determined using a standard pH meter on a 28% solids (by weight) mixture of the clay with deionized water in accordance with the ASTM D-1208, E-70 procedure.

Dry pigment brightness values in Table 2 were measured at 530 nm with a magnesium oxide standard equal to 100%, following the ASTM C-110 procedure. Hegman grind values were determined following the standard ASTM D-1210 procedure. The average Stokes equivalent particle diameters in microns were determined by an X-ray sedimentation method based on Stokes Law using a Micromeritics 5100 Sedigraph particle size instrument. The average Stokes equivalent particle diameter is the median particle size (MPS) value determined by the x-ray Sedigraph. The median particle size values, measured by the laser light scattering (LLS) method and reported in microns, were determined using a Malvern Mastersizer/E instrument which is based on Fraunhofer diffraction as generally described in U.S. Pat. No. 5,167,707, incorporated herein by reference, and references cited therein. BET surface areas were determined by the nitrogen absorption method described by Brunauer, Emett, and Teller in the “Journal of the American Chemical Society,” Volume 60, page 309, published in 1938. A multi-point surface area determination was made on the clay test samples after outgassing them at 130° C. using a Micromeritics Gemini III 2375 instrument. Oil absorbance values were determined from the grams of linseed oil absorbed per 100 grams of pigment by the rub-out method of ASTM-D.281. Loose and tapped bulk densities were determined by the procedures described in ASTM D-1895.

In one preferred embodiment, Polygloss® 90 or Huber® 35 commercial clay is used singly, or as blend of these, as the clay substrate powder that is surface treated with a polysiloxane having a silicon-hydride moiety in accordance with embodiments of the present invention. This range of clay particle sizes are well suited for coating compounds since the fineness of the particles is important to the resultant Hegman grind values and coating viscosities.

It is surprising that the PHS surface reagent, when used to modify the clay surface, produces a pigment with unexpectedly high anticorrosive properties beyond other surface reagents. Other surface reagents such as amino-, epoxy-, and isocyanato-silane surface reagents were be expected to provide higher anticorrosion properties than the PHS surface reagent since these would crosslink the clay with the resin and thus help to eliminate coating voids. Likewise, isobutyl-silane was expected to provide higher anticorrosion properties than the PHS surface reagent since it is known to provide clay with a highly hydrophobic surface and thus was expected to prevent water migration through the coating. These are included in the Examples below.

Resin

In one embodiment, the resin is a curable resin that is a binder material susceptible to being crosslinked to form a thermoset resin that binds the ingredients of the coating composition together to form a thin film. The curable resin will be included in sufficient amounts in the coating composition for this purpose.

The coating film hardens as the resin or binder cures, and thus becomes more durable among other things. The coatings can be air-dried or baked coatings. In one embodiment, the coating compositions can be in the form of a dispersion coating, emulsion, or latex.

As indicated, the curable resin is a crosslinkable resin forming a thermoset. Crosslinking generally toughens and stiffens the coatings. Thermosetting resins may soften but will not dissolve in any solvents, unlike thermoplastic resins. The coating composition can include curing agents or initiators or accelerators as applicable or needed. The curable resin generally composes about 1 to about 90 weight %, particularly about 10 to about 30 weight %, of the coating composition.

For purposes of the coating composition, the curable resin can be, for example, an epoxy resin, an epoxy ester, an isocyanate based urethane or urea resin, an alkyd resin, a uralkyd resin, a thermosetting acrylic(copolymer) resin, a polyester resin, a phenolic resin, a thermosetting polyvinyl resin, a blocked isocyanate resin, and so forth, and mixtures of these.

In one embodiment, curable organic film-forming binders are used that are suitable for aqueous coating compositions, which are, for example, 2-component epoxy resins; alkyd resins; polyurethane resins; polyester resins, which are usually saturated; water-dilutable phenolic resins or derived dispersions; water-dilutable amino-formaldehyde resins; and hybrid systems based on epoxy acrylates. Other resins that can be used include acrylic resins and resins based on vinyl-acrylic copolymers.

Preferred epoxy resins are those based on aromatic polyols, especially those based on bisphenols. The epoxy resins are employed in combination with crosslinking agents. The latter may in particular be amino- or hydroxy-functional compounds, an acid, an acid anhydride or a Lewis acid. Examples thereof are modified and unmodified aliphatic, aromatic and cycloaliphatic polyamines, polyamides, polyamidoamines, polyxylyene amines, Mannich Bases, polyoxyalkylamines polymers based on polysulfides, polyphenol- and amino-formaldehyde resins, boron trifluorides and their complex compounds, polycarboxylic acids, 1,2-dicarboxylic anhydrides, or pyromellitic anhydride. In combination with appropriate polyamine crosslinking agents, water-dilutable epoxy resins exhibit excellent mechanical and chemical resistance. The use of solid resins or solid-resin dispersions normally requires the addition of small amounts of solvent in order to improve film formation.

In one preferred embodiment, the coating composition resin system comprises a curable resin side and a curing agent side. The pigment is dispersed in either the curable resin side or the curing agent side. In a particular embodiment, the coating composition is a two part epoxy resin coating system comprised by a curable epoxy resin in one part and an amine hardening agent included in a second part, which upon admixture induces curing and hardening of the epoxy resin. The surface treated clay, and any other pigments, may be included in either or both parts. The epoxy or other curable resin included binds the additive particles together to form a film.

The alkyd resins can be water-dilutable alkyd resin systems which can be employed in air-drying form or in the form of stoving systems, optionally in combination with water-dilutable melamine resins; they may also be oxidatively drying, air-drying or stoving systems which can be employed optionally in combination with aqueous dispersions based on acrylic resins or their copolymers, with vinyl acetates and other such polymers.

Polyurethane resins are derived from polyethers, polyesters, polyacrylic, polycaprolactam and other polyols, and polybutadienes with terminal hydroxyl groups, on the one side, and from aliphatic or aromatic polyisocyanates on the other side. Other hydrogen donors could be used such as amines giving polyureas, thiols, and so forth. Suitable phenolic resins are synthetic resins in whose synthesis phenols are the principal component, i.e. in particular phenol-, cresol-, xylenol- and resorcinol-formaldehyde resins, alkylphenolic resins, and condensation products of phenols with acetaldehyde, furfurol, acrolein or other aldehydes. Modified phenolic resins also can be used.

Other types of resins alternatively or in combination with the curable resins can be used. For instance, thermoplastic resins and/or resins supporting coalescing systems can be used. Examples of thermoplastic resins include, for example, acrylic resins that are pure acrylic resins, epoxy acrylate hybrid systems, acrylic acid or acrylic ester copolymers, combinations with vinyl resins or copolymers of vinyl monomers such as vinyl acetate, styrene or butadiene. These systems can be air-drying or stoving systems. Examples of suitable polyvinyl resins are polyvinylacetals, polyvinyl chloride, polyvinylidene chloride polyvinyl acetate or copolymers thereof. Coalescing systems can be supported by resins that are thermosets or thermoplastics, especially those suitable for water-based emulsion or latex systems.

Optional Coating Composition Components

In one embodiment, the coating composition also includes pigments other than the surface-treated clay. Other pigments that optionally can be additionally used in the coating composition include, for example, titanium dioxide, iron oxide, aluminum bronze, hansa yellow, phthalo green, phthalocyanine blue, and so forth. The coating composition also may contain fillers such as talc, mica, silicate powder, alumina, aluminum trihydroxide, barite, carbon black, calcium carbonate, calcium silicate, chopped glass, and so forth. The coating compositions also optionally can contain commonly used chemical additives for protective coatings such as corrosion, oxidation, drying, and/or skinning retardants and inhibitors; curing agents; dispersants; dyes, flow control agents, thixotropic agents, adhesion promoters, light stabilizers, curing catalysts, and so forth. The supplemental anticorrosion agents can be, for example, anticorrosion pigments, such as phosphate-, molybdate-, or borate-containing pigments or metal oxide pigments, or other organic or inorganic corrosion inhibitors, for example salts of nitroisophthalic acid, phosphoric esters, industrial amines or substituted benzotriazoles. These optional additives can be used in amounts generally applied for their respective functions.

Flow control agents and thixotropic agents are based, for example, on silicone fluids, fluorochemical surfactants, polyoctyl acrylate resins, modified bentonite clays, high molecular weight polyolefin pastes, hydrogenated castor oil derivatives.

In another embodiment, it is also advantageous to add basic fillers or pigments, which in certain binder systems bring about a synergistic effect on the inhibition of corrosion. Examples of such basic fillers and pigments are calcium silicate, calcium or magnesium oxide, calcium carbonate or magnesium carbonate, zinc oxide, zinc carbonate, zinc phosphate, magnesium oxide, alumina, aluminum phosphate, barium sulfate, or mixtures thereof. Examples of basic organic pigments are those based on aminoanthraquinone.

The corrosion inhibitors can be added to the surface-coating material during its production, for example during the dispersion of the pigment by milling, or else the inhibitor is dissolved in a solvent and then stirred into the coating composition. The solutions of the corrosion inhibitors can also be used to pretreat the metal surface.

In the preparation of the organic film-forming binder by addition polymerization or polycondensation of monomers, the corrosion inhibitors can be mixed in with the monomers prior to polymerization, either in solid form or in solution.

The coating compositions generally, but not in every case, will also include some level of liquid solvent and/or diluent. Solvents are generally used to thin the coating composition by dissolving or dispersing the film forming particles, while diluents increase the capacity of a solvent for the binder.

Methods

The silicon-hydride polysiloxane surface treated clay used in the coating compositions of embodiments of the present invention is prepared by treating either dry, finely divided clay powder or a clay slurry with a silicon-hydride polysiloxane. Effective surface treatments on the clay particles can be carried out on either physical form (dry or slurry) by using a neat polysiloxane, or by adding an aqueous emulsion of the polysiloxane as more fully described below.

In one illustration, initially, 98 to 99.9 parts by weight of a quantity of clay (e.g., Polygloss® 90 or Huber® 35 clay, or a blend of these) is added to a solids/liquid batch blender. The blender is turned on and 0.1 to 2.0 parts by weight (on an active basis) of the silicon-hydride polysiloxane is added respectively over approximately 0.1 to 3 minutes so as to yield a total of 100 parts by weight. The total mixing time is preferably 5 to 40 minutes. The preferred treatment level of the polysiloxane is from about 0.25% to about 1.5% by weight. Optionally, the clay may be heated during the dry treatment and subsequent mixing steps. In the case of surface treating a dry clay powder with silicon-hydride polysiloxanes at room temperature, the treated clay product should be allowed to sit for a period of about 24-48 hours prior to its use to insure that the surface reaction is complete.

Alternatively, the dry treatment process can be carried out continuously by adding silicon-hydride polysiloxanes (neat or as an aqueous emulsion) via a chemical metering pump that is used in combination with a pin mixer, a Bepex turbulizer unit or a similar continuous blending device. If a clay starting material is to be treated in slurry form, the silicon-hydride polysiloxane (neat or as an aqueous emulsion) is added slowly to the slurry with good mixing and then mixed for an additional 5 to 30 minutes. The treated clay slurry is then flash-dried, or spray dried, or vacuum filtered and subsequently oven dried under conventional drying conditions. Whether surface treated in dry particulate form or in slurry form followed by drying, the treated clay product can be optionally post-pulverized to reduce treated particle agglomeration thereby improving its Hegman grind properties.

In an alternative non-limiting method, an aqueous emulsion of a silicon-hydride polysiloxane is used to surface treat the clay. The aqueous emulsion is preferably prepared from a high-speed dispersion of the silicon-hydride polysiloxane in water in the presence of a surfactant. In a preferred embodiment, the aqueous emulsion comprises silicon-hydride polysiloxane in an amount of from about 30% to about 70%, and a nonionic surfactant in an amount of from about 1.0% to about 3.0% of the total formulation (percentages are on an active weight basis).

It has been found that the optimum amount of nonionic surfactant used in preparing the emulsion formulation described above is about 4.0% by weight of the silicon-hydride polysiloxane component. Further, preferred nonionic surfactants have a hydrophilic lypophilic balance (HLB) value of greater than 9. In one non-limiting embodiment, a nonionic surfactant particularly suited for emulsifying the silicon-hydride polysiloxane is a polysorbitan monolaurate with 20 moles of ethoxylation available under the trade name Alkamuls PSML-20 from Rhodia. In order to obtain sufficient stability in some circumstances, the emulsions may be prepared at about 50% by weight concentration of silicon-hydride polysiloxane whereby the corresponding weight concentration of Alkamuls PSML-20 utilized therein would optimally be about 2%.

The silicon-hydride polysiloxane surface treated clay is then combined with the curable resin and any other additives, in well established order, with sufficient mixing or blending to provide an essentially uniform dispersion of all the components in the resulting flowable composition.

The film forming coating compositions of this invention can be used, for example, as anticorrosive primers, chemical resistance coatings, sealers, top coats, varnishes, and tank linings. These coatings can be applied to a solid surface by spraying, brushing, dipping, electrodeposition, or any other suitable technique.

In some applications, two or more coats are applied in forming a surface coating or film, either as wet-on-wet or wet-on-dry coating schemes. If corrosion inhibitors are used, they are primarily added to the basecoat (primer), since they act in particular at the metal/coating interface. However, they can also be added to the intermediate coat or topcoat as well. Depending on whether the binder is a physically, chemically or oxidatively drying resin or a heat- or radiation-curing resin, the coating is cured at room temperature or by heating (stoving) or by irradiation. The compositions of the present invention form durable continuous thin films that generally can have an average film thickness, upon drying, of about 1×10⁻³ to about 25×10⁻³ inch, more particularly about 2×10⁻³ to about 15×10⁻³ inch.

The coating compositions described herein are more blister resistant as compared to similar coating compositions containing clay that has not been surface treated with a silicon-hydride polysiloxane or alternatively has been surface treated with a different silane or siloxane chemistry other than silicon-hydride polysiloxane. In addition, the film forming coating composition also provides excellent corrosion resistance. This attribute helps eliminate the need for use of undesirable metal pigments for corrosion control.

In addition, the coating compositions of this invention also have acceptibly low viscosities that are well suited for coating applications.

The invention will now be described in more detail with respect to the following, specific, non-limiting examples.

### EXAMPLES

A series of clay samples were surface treated with different silane and siloxane surface reagents indicated in Table 3 below. The abbreviations used for these silane reagents elsewhere in the examples are indicated in Table 3 for sake of convenience.

TABLE 3
Surface reagents investigated to surface modify clay.

| | |
|---|---|
| Present Invention | Polymethylhydrogensiloxane¹ (″PHS″) |
| Comparison | 3-Aminopropyltriethoxysilane^{2a} (″AS″) |
| Comparison | 3-Glycidoxypropyltrimethoxysilane^{2b} (″GS″) |
| Comparison | iso-Butyltriethoxysilane^{2c} (″iBS″) |
| Comparison | 3-Isocyanatopropyltriethoxysilane³ (″IS″) |
| Comparison | None (“N”) |

¹Polymethylhydrogensiloxane is available from Dow Corning Corporation under the trade name Silicone Fluid 1107.
²These silanes are available from Degussa Corporation as AMEO^{2a}, GLYMO^{2b}, and IBTEO^{2c}, respectively.
³Isocyanatopropyltriethoxysilane is available from GE OSi Corp. as A-1310.

Table 4 lists the clay test samples that were surface modified with the reagents in Table 3 along with their corresponding descriptions. The clays employed herein were Polygloss® 90, a 0.2 micron particle sized water-washed kaolin clay, Huber® 35, a 2.5 micron particle sized water-washed kaolin clay, and a 1:8 blend of Polygloss® 90 and Huber® 35, respectively. Blends of different sized clay products were used in some examples to provide a wider distribution of particles sizes.

TABLE 4
Clay Samples

| Clay Sample | Description of Surface Treatment Applied |
|---|---|
| Base (untreated) | |
| clays | |
| Clay 1 | 0.2 micron MPS, water-washed clay¹ |
| Clay 2 | 2.5 micron MPS, water-washed clay² |
| Clays (1 + 2)/N | Blend of a 1:8 weight ratio of untreated Clay |
| | 1 and untreated Clay 2 |
| Surface reagent | |
| modified clay | |
| blend/(silane) | |
| Clays(1 + 2)/AS | Clays (1 + 2) surface modified with 0.44 wt. % |
| | AS |
| Clays(1 + 2)/GS | Clays (1 + 2) surface modified with 0.44 wt. % |
| | GS |
| Clays(1 + 2)/IS | Clays (1 + 2) surface modified with 0.44 wt. % |
| | IS |
| Clays(1 + 2)/iBS | Clays (1 + 2) surface modified with 0.44 wt. % |
| | iBS |
| Clays(1 + 2)/PHS | Clays (1 + 2) surface modified with 0.44 wt. % |
| | PHS |

¹Polygloss ® 90: kaolin clay available from J. M. Huber Corporation
²Huber ® 35: kaolin clay available from J. M. Huber Corporation

The same general method of preparation that was used to prepare the series of clay samples surface treated with one of PHS, AS, GS, IS, or iBS, is as follows. The surface treated clay of the present invention is prepared by treating either dry, finely divided clay powder or a clay slurry with a silicon-hydride containing polysiloxane. Effective surface treatments on the clay particles can be carried out on either physical form of clay (dry or slurry) and by using either a neat or aqueous emulsion of the polysiloxane as more fully described below. Initially, 98 to 99.9 parts by weight of quantity of the blended clay (e.g., 1:8 Polygloss® 90/Huber® 35 clay) is added to a solids/liquid batch blender. The blender is turned on and 0.1 to 2.0 parts by weight (on an active basis) of the silicon-hydride polysiloxane is added respectively over approximately 0.1 to 3 minutes so as to yield a total of 100 parts by weight. The total mixing time is preferably 5 to 40 minutes. The preferred treatment level of the silicon-hydride polysiloxane is from about 0.1% to about 2.0% by weight. Optionally, the clay may be heated during the dry treatment and subsequent mixing steps. In the case of surface treating a dry clay powder with silicon-hydride polysiloxane at room temperature, the treated clay product should be allowed to sit for a period of about 24-48 hours prior to its use to insure that the surface reaction is complete.

Alternatively, the dry treatment process can be carried out continuously by adding a silicon-hydride polysiloxane (neat or as an aqueous emulsion) via a chemical metering pump that is used in combination with a pin mixer, a Bepex turbulizer unit or a similar continuous blending device. If a clay starting material is to be treated in slurry form, the silicon-hydride polysiloxane is added slowly to the slurry with good mixing and then mixed for an additional 5 to 30 minutes. The treated clay slurry is then vacuum filtered and subsequently oven dried, spray-dried or flash-dried under conventional drying conditions. Whether surface treated in dry particulate form or in slurry form followed by drying, the treated clay product can be optionally post-pulverized to reduce treated particle agglomeration thereby improving its Hegman grind properties.

Table 5 sets forth some typical physical properties of the silicon-hydride polysiloxane treated clay product that was produced by surface treating a 1:8 blend of Polygloss® 90 and Huber® 35 clay with 0.44% by weight of the silicon-hydride polysiloxane (“PHS”).

TABLE 5

| | PHS-Treated Clay |
|---|---|
| General Specifications | |
| Moisture, 105° C. (max), % | 1.0 |
| Screen Residue*, 325 mesh (max), % | 0.05 |
| Hegman Grind ASTM D-1210 | 4+ |
| Physical Properties | |
| Form | Fine Powder |
| bulk density, loose (lb/ft³) | 29 |
| bulk density, tamped (lb/ft³) | 39 |

A modified test procedure was used for determining the % screen residue of a treated clay product, as follows: Using 100.0 grams of pigment, a 38% solids dispersion in isopropanol was produced and poured through a 325 mesh sieve screen. After washing with an additional 100 gm quantity of isopropanol, the residue was dried, collected and then weighed.

Several illustrative, non-limiting generalized coating formulations, Coatings 1 and 2, representing this invention are set forth below in Table 6, which were employed in Examples 1 and 2 described below.

Both the epoxy/cycloaliphatic amine and epoxy/polyamide binder systems used were based on a low molecular weight epoxy resin. Epoxy bases were all made by combining the formulation ingredients in the order shown in Table 6 in a metal mixing container and mixed on a high-speed disperser such as a Cowles disperser with a high shear blade for three minutes each. There was no pigmentation of the epoxy curing agent component though this is an optional procedure. Each coating sample was allowed to remain at room temperature for two weeks prior to the curing agent being added. After that time, the coating samples were mixed with the curing agent.

TABLE 6
High PVC 2-Part Barrier Coating Formulations.

| | Coating 1 | | Coating 2 | |
|---|---|---|---|---|
| | Cycloaliphatic amine | | Polyamide | |
| | 44.9% PVC | | 43.8% PVC | |
| Ingredient | Lbs. | gals | Lbs. | gals |
| Part 1: | | | | |
| Epoxy resin¹ | 302.16 | 31.2 | 302.2 | 31.2 |
| Xylene | 23.4 | 3.23 | 23.4 | 3.23 |
| Rheology modifier² | 10.38 | 0.769 | 15.0 | 1.11 |
| Air-release agent³ | 0.070 | 0.0091 | 0.070 | 0.0091 |
| n-Butyl alcohol | 2.9 | 0.43 | 2.9 | 0.43 |
| Methylethyl ketone | 12.5 | 1.86 | 12.5 | 1.86 |
| Titanium oxide⁴ | 500 | 15.0 | 500 | 15.0 |
| Clay⁵ | 600.4 | 27.4 | 600.4 | 27.4 |
| Xylene | 255 | 35.2 | 255 | 35.2 |
| Flow control agent⁷ | 9.09 | 1.04 | 9.09 | 1.04 |
| Part 2: | | | | |
| Polyamide | 0 | 0 | 202.16 | 24.1 |
| crosslinking agent⁸ | | | | |
| Cycloaliphatic amine | 182.58 | 21.2 | 0 | 0 |
| crosslinking agent | | | | |
| TOTAL | 1898 | 137 | 1923 | 141 |

(1) Polyepoxide resins based on diglycidyl ether of bisphenol A such as Epon 828®. Epoxy phenol, novolac resins, halogenated polyepoxide resins, cycloaliphatic polyepoxide resins, and solutions thereof might also have been used with compensation for equivalent weight.

(2) Bentone SD-2. Other thixatropes might have been used such as high molecular weight polyolefins (MPA-1078X), hydrogenated castor oil derivatives (Thixatrol ST), fumed silicas such as but not limited to, Cab-O-Sil TS-720, TS-610, TS-530,M-5®, other treated clays such as Bentone 38® and Bentone SD-1®, polyamide waxes such as Crayvallac Extra®, attapulgite clays such as Attagel 50®, mixed mineral thixotropes such as Garamite 1958®, or equivalents.

(3) Silicone-free air release agents, such as Dehydran ARA 7219®, supplied by Cognis.

(4) Titanium oxide such as TiPure R-706® supplied by Dupont.

(5) Clay substrates with median particle diameters of 0.2-5.0 microns, such as, but not limited to, Polygloss® 90 and Huber® 35 made by J.M. Huber Corp. with silane and polysiloxane surface treatments as described herein (Table 4).

(6) Amorphous silica such as Zeodent® silicas, commercially available from J.M. Huber Corporation.

(7) A flow control agent such as urea-formaldehyde resin commercially available as Cymel U 216-8®, supplied by Cytec.

(8) Modified and unmodified aliphatic polyamides, such as Ancamide 2050® and Versamid 253®.

(9) Modified and unmodified cycloaliphatic polyamines, such as Ancamine 1618® (Air Products) or Versamine C-30 (Cognis).

In order to test the performance of these coating compositions and the effect thereon of the surface treatment provided on the clay, the following experiments were conducted.

### Experimental Protocol

Ground steel panels (4″×8″) were coated at about 4.0±0.5 mils (dry) with each of the coating samples indicated below. The panels were scribed to the metal with a tungsten carbide scribing tool after backing and edging with adhesive vinyl tape. The coated steel panels were then performance tested in salt spray in accordance with ASTM B 117.

Each panel was evaluated and the results are listed in Tables 7 and 8 under the category of “General Scribe Corrosion” for deterioration at the scribe including blistering and corrosive undercutting at the scribe. Scribe deterioration was evaluated using a template based on Table 7 of ASTM D 1654. Evaluations were assessed on the basis of the furthest encroachment of corrosion or blister formation into the general panel area from the scribe line.

“Blistering Degree” and “Blistering Size” were evaluated over the remainder of the panel. Blistering was assessed according to modified version of ASTM 714. The degree of blistering was assessed numerically so that the qualitative ASTM assessment of blistering degree of “Few” is assessed as 8, “Medium” as 6, “Medium Dense” as 4 and “Dense” as 2, and no blisters is assessed as 10.

After these evaluations, the films were stripped from each panel and the condition of the bare steel in the general area beneath the coating and of the steel along the scribe line were evaluated. These results are listed under “Bare Panel Corrosion” and “Bare Scribe Corrosion” also in Tables 7 and 8. These evaluations were made according to ASTM D 610. At the end of the evaluations, all five evaluation criteria were averaged to give a single “Overall Panel Rating” value for each coating sample.

### Example 1

5% Salt Spray Corrosion Results of Clay-Epoxy-Cycloaliphatic Amine Coating Formulations.

Anti-corrosion results using the high PVC epoxy-cycloaliphatic amine formulations of Coating 1 (Table 6) are shown in Table 7. The epoxy-cycloaliphatic amine coating formulation provides a relatively rigid, inflexible coating in which to test the anti-corrosion properties of the surface modified clays. The epoxy resin was Epon 828; the rheology modifier was Bentone SD-2; the air-release agent was Dehydran ARA 7219; the flow control agent was Cymel U 216-8; the cycloaliphatic amine crosslinking agent was Ancamine 1618; otherwise the ingredients used in the tested coating composition were the compounds already specifically set forth in Table 6 for Coating 1.

The anticorrosion data are sorted in descending order by “Overall Panel Rating” which is an average of all other corrosion categories in Table 7. Individual corrosion ratings are averages of two test panels.

TABLE 7
Salt spray corrosion results of surface modified clay in a high
PVC epoxy-cycloaliphatic amine coating on steel; 720 hr.

| | General | | | | | Overall |
|---|---|---|---|---|---|---|
| Surface reagent | Scribe | Blistering | Blistering | Bare Panel | Bare Scribe | Panel |
| modified clay blend | Corrosion | Degree | Size | Corrosion | Corrosion | Rating |
| Clays(1 + 2)/PHS | 6.0 | 6.5 | 4.0 | 8.5 | 4.0 | 5.8 |
| Clays(1 + 2)/iBS | 0.0 | 0.0 | 0.0 | 6.5 | 2.5 | 1.8 |
| Clays(1 + 2)/ES | 0.0 | 0.0 | 0.0 | 4.5 | 3.0 | 1.5 |
| Clays(1 + 2)/N | 2.5 | 1.0 | 1.0 | 1.5 | 1.5 | 1.5 |
| Clays(1 + 2)/IS | 0.0 | 0.0 | 0.0 | 4.0 | 2.0 | 1.2 |
| Clays(1 + 2)/AS | 0.0 | 0.0 | 0.0 | 1.5 | 1.5 | 0.6 |

The data in Table 7 clearly show that the formulation containing PHS treated clay surprisingly and singularly exhibits superior general scribe (6.0), blistering degree (6.5), and blistering size (4.0) performance, well beyond all other samples. The PHS treated clay sample also outperformed all other samples in bare panel corrosion (8.5) while the iBS treated clay had the next best performance. The PHS treated clay sample had the highest bare scribe rating as well (4.0). These data gave the PHS treated clay sample the best overall anti-corrosion performance (5.8). The other surface reagents, e.g. GS, IS, AS, yielded treated clays that are unexpectedly either not significantly better than or, in fact, worse than the untreated clay sample.

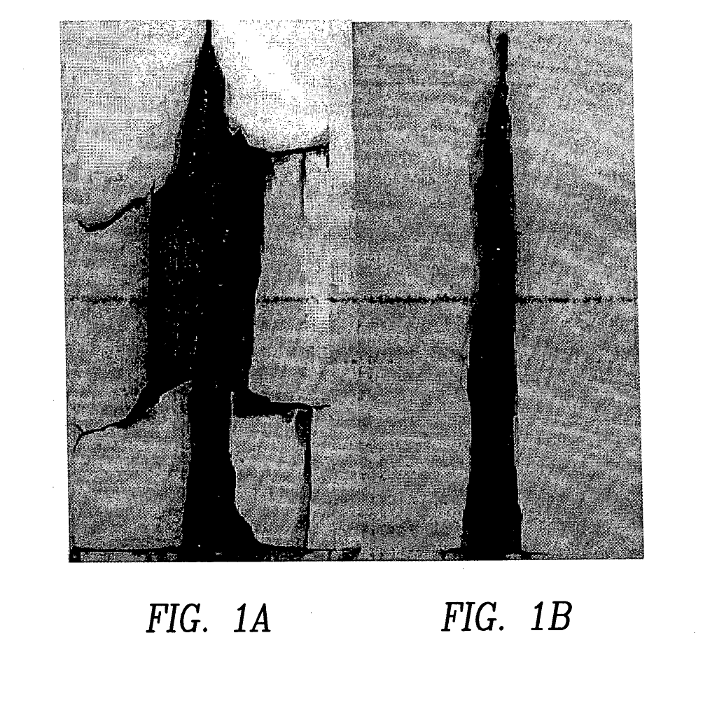

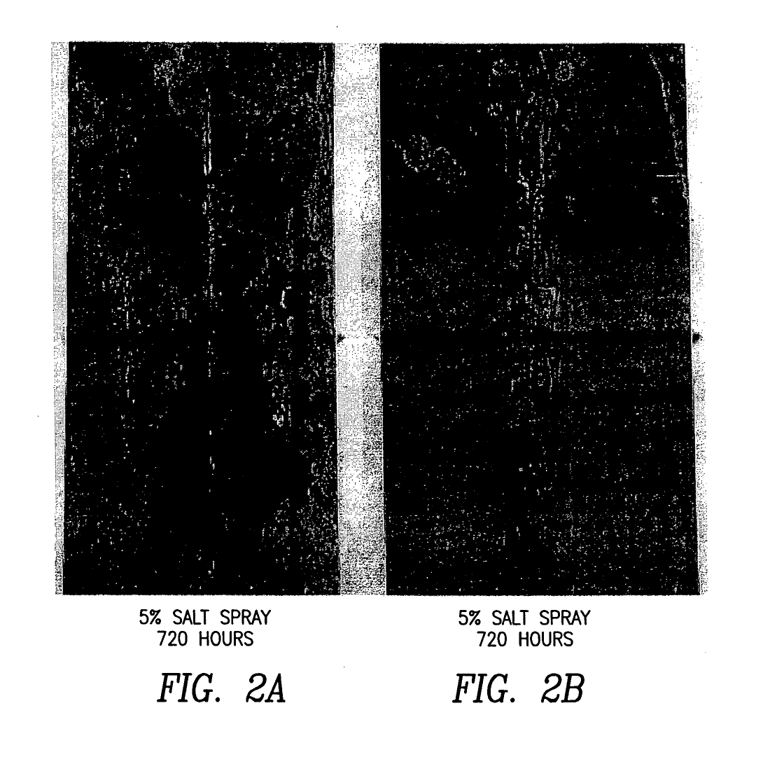

FIG. 1 shows the epoxy-cycloaliphatic amine coatings on steel panels which contain the untreated clay blend (1A, Clays(1+2/N)) and the clay blend surface modified with PHS (1B, Clays(1+2/PHS)) after 720 hours of 5% salt spray. The severe delamination and cracking of the coating on panel 1A (untreated clay) is clearly evident. The coating on panel 1B containing the inventive PHS treated clay shows excellent adhesion and only minimal corrosion which is limited to the exposed scribe line. The panels with the coatings removed are shown in FIG. 2. Panel 2A (untreated clay) exhibits a completely corroded metal surface whereas Panel 2B that was protected by the inventive PHS treated clay, exhibits almost no corrosion except along the originally exposed scribe line.

### Example 2

5% Salt Spray Corrosion Results of Clay-Epoxy-Polyamide Coating Formulations

Anti-corrosion results using the high PVC epoxy-polyamide formulations of Coating 2 are shown in Table 8. The epoxy resin was Epon 828; the rheology modifier was Bentone SD-2; the air-release agent was Dehydran ARA 7219; the flow control agent was Cymel U 216-8; the polyamide crosslinking agent was Versamid 253; otherwise the ingredients used in the tested coating composition were the compounds already specifically set forth in Table 6 for Coating 2. The data are sorted in descending order by “Overall Panel Rating”. Individual corrosion ratings are averages of two test panels.

TABLE 8
Salt spray corrosion results of surface modified clay in
a high PVC epoxy-polyamide coating on steel; 744 hr.

| | General | | | | | Overall |
|---|---|---|---|---|---|---|
| Surface reagent | Scribe | Blistering | Blistering | Bare Panel | Bare Scribe | Panel |
| modified clay blend | Corrosion | Degree | Size | Corrosion | Corrosion | Rating |
| Clays(1 + 2)/PHS | 5.0 | 8.8 | 4.5 | 8.3 | 5.0 | 6.3 |
| Clays(1 + 2)/GS | 4.5 | 5.0 | 4.0 | 10.0 | 4.0 | 5.5 |
| Clays(1 + 2)/iBS | 3.8 | 4.5 | 5.5 | 9.0 | 3.0 | 5.2 |
| Clays(1 + 2)/IS | 3.5 | 4.0 | 4.8 | 10.0 | 3.5 | 5.2 |
| Clays(1 + 2)/AS | 3.8 | 3.0 | 3.0 | 10.0 | 5.0 | 5.0 |
| Clays(1 + 2)/N | 2.8 | 2.0 | 4.5 | 3.5 | 3.0 | 3.2 |

The PHS-treated clay provided the highest “General Scribe Corrosion” value of all samples (5.0). Further, the PHS-treated clay was superior to all other samples for preventing “Blistering Degree” (8.8). The remaining surface reagents provided some “Blistering Degree” improvement over the untreated clay though these were inferior to that for the PHS-treated clay. All surface modified clays significantly improved “Bare Panel Corrosion” over untreated clay. The “Overall Panel Rating” value was highest for the PHS treated clay (6.3).

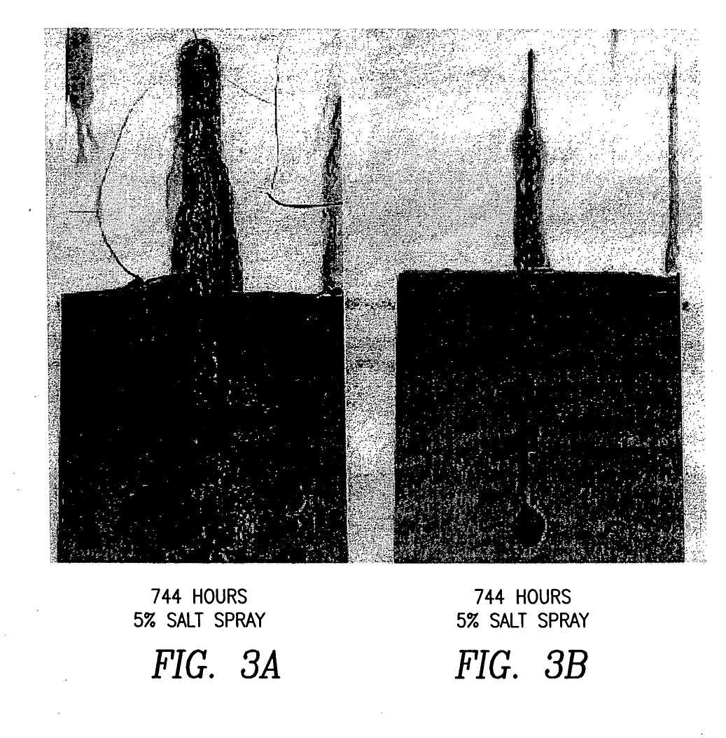

FIG. 3 contains photographs of two epoxy-polyamide coated steel panels which were exposed to 5% salt spray for 744 hours with bottom half of the coatings removed. Thus panel 3A demonstrates the performance of the coating containing unmodified blended clay (Clays(1+2)/N), and panel 3B demonstrates the performance of the coating containing blended clay surface modified with polymethylhydrogensiloxane (Clays(1+2)/PHS).

The upper portion of panel 3B (inventive PHS treated clay) exhibits a resilient, continuous, blister-free coating which is indicative of excellent adhesion. This strongly contrasts the severe delamination and cracking of the coating in the upper half of panel 3A (untreated clay). Likewise, the lower half of 3B is corrosion-free except for minor corrosion migration from the exposed scribe line while the lower half of panel 3A exhibits almost complete surface corrosion.

The inventive PHS-treated clay showed excellent anticorrosion performance in this second Example using an epoxy-polyamide resin demonstrating that it has high versatility for corrosion protection properties in various coating formulations.

As is readily apparent from the data and the figures, the coatings with clay treated in accordance with the present invention yields superior resistance to blistering and higher corrosion resistance as compared to untreated clay or clays that have been surface treated with surface reagents other than silicon-hydride polysiloxane in epoxy coatings.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A coating composition useful for forming a film, comprising, in admixture, a resin and finely divided clay that has been surface treated with a silicon-hydride containing polysiloxane.

2. The coating composition according to claim 1, wherein a film formed from the coating composition has a blistering degree of 6 or greater, wherein the blistering degree is determined according to ASTM 714 with the proviso that the blistering degree was assessed numerically wherein the qualitative ASTM 714 assessment of blistering degree of no blisters is assessed as 10, “Few” is assessed as 8, “Medium” as 6, “Medium Dense” as 4, and “Dense” as 2.

3. The coating composition according to claim 1, wherein the clay has a median particle size in the range of approximately 0.1 to approximately 10 microns.

4. The coating composition according to claim 1, wherein the silicon-hydride containing polysiloxane is represented by the following formula: 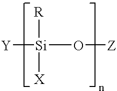
wherein
n=an integer greater than 1;
X=H or R′;
R or R′=an organic substituent comprising 1 to 20 carbon atoms; and
Y and Z=silicon-containing terminating end groups.

5. The coating composition according to claim 1, wherein the silicon-hydride containing polysiloxane is added onto the surface of the clay when surface treated with the polysiloxane in an amount of about 0.1% to about 2%, based on dry weight of the clay before the addition.

6. The coating composition according to claim 1, further comprising a pigment including the finely divided clay that has been surface treated with a silicon-hydride containing polysiloxane.

7. The coating composition according to claim 6, wherein the pigment comprises about 1 to about 65% by volume of the coating composition.

8. The coating composition according to claim 6, wherein the pigment has a total volume, and the clay comprises about 1 to about 100% of the total volume of the pigment.

9. The coating composition according to claim 6, wherein the resin comprises a curable resin.

10. The coating composition according to claim 1, wherein the resin comprises a curable resin selected from the group consisting of epoxy resins, polyurethane resins, alkyd resins, melamine resins, phenolic resins, polyester resins, individually or in combinations thereof.

11. The coating composition according to claim 9, wherein the curable resin comprises an epoxy resin and a curing agent.

12. The coating composition according to claim 1, wherein the coating composition comprises a coalescing system.

13. The coating composition according to claim 1, wherein the resin comprises a thermoplastic resin.

14. The coating composition according to claim 1, having a pigment volume concentration (PVC)/critical pigment volume concentration (CPVC) ratio value of 0.1 to 0.95.

15. A dry film, comprising a dried coating having an average film thickness of about 1×10⁻³ to about 25×10⁻³ inch and the coating having a composition comprising a thermoset resin into which is dispersed finely divided clay having surfaces that have been treated with a silicon-hydride containing polysiloxane.

16. A method of providing a coating film on a solid substrate surface comprising:
applying a coating composition on the substrate surface in film form, wherein the coating composition comprises a resin system, and a dispersion in the resin system, wherein the dispersion comprises a pigment including clay particles surface treated with a silicon-hydride containing polysiloxane, and
drying or permitting drying of the film to form a dried film from the applied coating composition, which film is attached to the solid substrate surface.

17. The method of claim 16, wherein the resin comprises a curable resin is selected from the group consisting of epoxy resins, polyurethane resins, alkyd resins, melamine resins, phenolic resins, polyester resins, individually or in combinations thereof.

18. The method of claim 16, wherein the resin system comprises a mixture of first and second components, wherein the first component comprises a curable resin, and the second component comprises a curing agent for the curable resin.

19. The method of claim 16, wherein the resin system comprises a coalescing system.

20. The method of claim 16, wherein the resin comprises a thermoplastic resin.

21. The method of claim 16, wherein the applying is performed effective that the coating composition forms a dry film having an average film thickness of about 1×10⁻³ to about 25×10⁻³ inch.

22. The method of claim 16, wherein the contacting of the substrate surface with coating composition is repeated at least once.

23. The method of claim 16, wherein the contacting of the substrate surface with the coating composition comprises using an application technique selected from at least one of brushing, spraying, blade coating, rolling, or dipping.

24. The method of claim 16, wherein the substrate surface is a metallic surface.

25. The coated substrate product of the method of claim 16.
